(19) United States
(12) Patent Application Publication
(10) Pub. No.: US 2009/0121372 A1
(43) Pub. Date: May 14, 2009

(54) Method and Apparatus for Pelletizing A Polymer Feed

(76) Inventors: David A. Campbell, Crosby, TX (US); Patrick S. Byrne, Baton Rouge, LA (US); Ramin Abhari, Bixby, OK (US); David R. Johnsrud, Humble, TX (US); Jay L. Reimers, Geismer, LA (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/256,973

(22) Filed: Oct. 23, 2008

Related U.S. Application Data
(60) Provisional application No. 60/986,515, filed on Nov. 8, 2007.

(51) Int. Cl. B29B 9/12; B28B 17/00

(52) U.S. Cl. 264/5; 425/6

(57) ABSTRACT

A method and apparatus are described in which a polymer feed is pelletized by introducing the polymer feed to an extruder, removing heat from the polymer feed in the extruder, and extruding the polymer feed through a pelletizing die.

### PRIORITY CLAIM

This application claims priority to and the benefit of U.S. Ser. No. 60/986,515, filed Nov. 08, 2007 which is hereby incorporated by reference.

### FIELD

This invention relates to a method and apparatus for pelletizing a polymer feed, such as a hot melt adhesive polymer feed.

### BACKGROUND

Olefin based polymers are widely used in various applications due to their being chemically inert, having low density, and low cost. Applications include adhesives, films, fibers, molded parts, and combinations thereof. While these polymers are solid at room temperature, they are often produced and processed as melts. The last step in the manufacturing process for such materials is converting the polymer melt into easily handled granules. Granules—pellets being one type—are advantageous as they can be easily packaged, transported, weighed/batched, and reprocessed.

Over the years, two different classes of granulation technology have evolved: granulation technology for low viscosity melts, e.g., viscosity less than 100 cP, and granulation technology for high viscosity melts, e.g. viscosity greater than 100,000 cP. Granulation of low viscosity melts is generally characterized by (1) applying a low viscosity melt onto a cooling surface, (2) cooling the melt into a solid, and (3) recovering the solid as flakes, pastilles, briquettes, granules, or other suitable forms. Often, however, the granulation step is skipped altogether for low viscosity melts, and the melts are packaged in transportable melt tanks. Granulation of high viscosity melts generally involves (1) extruding the high viscosity melt through a die and (2) cooling and cutting the resulting strands into pellets.

Although techniques have been developed for granulation of low viscosity and high viscosity melts, there is a gap in granulation technology for materials of intermediate viscosity, such as hot melt adhesives (HMAs). In general, melts with an intermediate viscosity have lower melt strength than melts with a high viscosity. This lower melt strength translates into a polymer melt that cannot be easily cut with traditional pelletizing techniques as the polymer melt has little to no definition or form. Thus, when these traditional granulation techniques are attempted with polymer melts having intermediate viscosity polymer wrap-ups around the cutter assembly often result.

Additionally, regardless of how the granules are formed, the tackiness of HMAs is a factor affecting HMA granulation. If the surface of the granule is tacky, this can lead to granule agglomeration. Agglomerated granules are then more difficult to re-melt for subsequent use than free-flowing, non-agglomerated, granules.

Conventional processes have attempted to address some of the problems associated with pelletizing HMAs, such as cutter wrap-ups and granule agglomeration, however, these and other problems still exist. For example, another problem associated with HMA pelletization is that as the polymer melt is cooled, crystallization often begins to occur and the polymer melt may lose homogeneity as the polymer components in the melt disperse and fall out of solution.

Furthermore, pelletization can also be difficult when the material being pelletized exhibits: a wide melting range, multiple melting ranges, a low temperature melting range, an intermediate viscosity, slow thermal conductivity and thus a lesser ability to cool rapidly for processing, a proclivity to undergo phase separation on cooling, delayed crystallization, surface tack, and/or an extreme temperature variance from the mixing and blending stage to the extrusion and pelletization stage, as all of these qualities can lead to poor pellet formation and poor pellet geometry.

Accordingly, there remains a need for a method and apparatus to pelletize polymer melts with an intermediate viscosity and/or polymer melts which exhibit delayed crystallization. In particular, it would be desirable to have a method to pelletize HMA compositions.

### SUMMARY

Provided are methods of pelletizing a polymer feed composed of the steps of introducing a polymer feed into an extruder, cooling the molten polymer feed while in the extruder to increase the viscosity of the polymer feed, and extruding the cooled polymer feed through a pelletizing die.

For example, methods of pelletizing a polymer feed having a viscosity at 190° C. of from about 10 cP to about 75,000 cP or from 100 cP to about 35,000 include the steps of introducing a molten polymer feed into an extruder, cooling the polymer feed while in the extruder to a pelletization temperature to raise the viscosity of the polymer feed to greater than 5000 cP, and extruding the cooled polymer feed through a pelletizing die. The pelletizing temperature may be: (a) sufficiently near, but above, the ring and ball softening point of the polymer feed while in the extruder such that the extruder increases the dispersive homogeneity of the polymer melt, (b) less than the ring and ball softening point of the polymer feed, (c) less than the ring and ball softening point of the polymer feed but greater than the crystallization temperature of the polymer feed while in the extruder, (d) sufficiently near, but above, the crystallization temperature of the polymer feed while in the extruder such that the extruder increases the dispersive homogeneity of the polymer melt, or (e) at or below the crystallization temperature of the polymer feed. In one embodiment, the extruder creates a pressure at the die face of at least 250 psi to force the cooled polymer feed through a pelletizing die.

Also provided is an apparatus for pelletizing a polymer feed composed of a melt cooler with an inlet and an outlet; an extruder with an inlet, a barrel, and an outlet, wherein the extruder inlet is attached to the melt cooler outlet; a heat removing device adapted to remove heat from the barrel of the extruder; and a pelletizing die attached to the outlet of the extruder e.g., an underwater pelletizing device; wherein the polymer feed flows through the extruder barrel and the heat removing device removes heat from the polymer feed to raise the viscosity of the polymer feed.

In a further embodiment, an apparatus for pelletizing a polymer feed comprises a melt cooler with an inlet and an outlet; an extruder with an inlet, a barrel, and an outlet, wherein the extruder inlet is attached to the melt cooler outlet; a heat removing device adapted to remove heat from the barrel of the extruder; and an underwater pelletizing die attached to the outlet of the extruder; wherein the polymer feed flows through the extruder barrel and the heat removing device removes heat from the polymer feed to increase the viscosity of the polymer feed to at least 5,000 cP.

### BRIEF DESCRIPTION OF THE FIGURES

FIG. 1 is a schematic illustration of an apparatus for pelletizing a polymer feed composed of a melt cooler, an underwater pelletizer, and a drying apparatus.

FIG. 2 is a schematic illustration of an apparatus for pelletizing a polymer feed composed of a melt cooler, a cooling extruder, an underwater pelletizer, and a drying apparatus.

FIG. 3 is a schematic illustration of an apparatus for pelletizing a polymer feed composed of an extruder, an underwater pelletizer, and a drying apparatus.

### DETAILED DESCRIPTION OF THE PREFERRED EMBODIMENTS

Provided are methods and apparatus for pelletizing a polymer feed. The methods are composed of the steps of introducing a polymer feed into an extruder, cooling the molten polymer feed while in the extruder to raise the viscosity of the polymer feed, and extruding the cooled polymer feed through a pelletizing die. The polymer feed is cooled to a pelletizing temperature that may be: (a) sufficiently near, but above, the ring and ball softening point of the polymer feed while in the extruder such that the extruder increases the dispersive homogeneity of the polymer melt, (b) less than the ring and ball softening point of the polymer feed, (c) less than the ring and ball softening point of the polymer feed but greater than the crystallization temperature of the polymer feed while in the extruder, (d) sufficiently near, but above, the crystallization temperature of the polymer feed while in the extruder such that the extruder increases the dispersive homogeneity of the polymer melt, or (e) at or below the crystallization temperature of the polymer feed. In one embodiment, the extruder creates a pressure at the die face of at least 250 psi to force the cooled polymer feed through a pelletizing die.

The methods and apparatus described herein are useful for pelletizing polymer feeds which are not easily pelletized, particularly those polymer feeds with an intermediate viscosity, polymers exhibiting a delayed crystallization, polymers that exhibit a wide melting range, have multiple melting ranges, or have a low temperature melting range. The method and apparatus are also particularly suitable for pelletizing polymer feeds which exhibit (a) sharp viscosity increases and undergo fouling or phase separation when cooled, (b) slow thermal conductivity and thus a lesser ability to cool rapidly for processing, (d) surface tack, or (d) a high temperature variance from the mixing and blending stage to the extrusion and pelletization stage. Each of these so called difficult-to-process qualities have led to poor pellet formation and poor pellet geometry in conventional pelletizing processes. Beneficially, the undesirable effects of these qualities are reduced by the methods and apparatus described herein.

In particular, the provided method and apparatus are useful for pelletizing an HMA polymer feed, wherein the HMA polymer feed is cooled to a temperature so that the viscosity is raised to a level where the HMA polymer feed is readily pelletized, all the while mixing the polymer feed to increase the dispersive homogeneity of the polymer feed.

Various specific embodiments, versions, and examples are described herein, including exemplary embodiments and definitions that are adopted for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

### Polymer Feed

The polymer feed is composed of polymers that include C₂ to C₄₀ olefins and blends thereof. Preferably the olefin is a homo or copolymer of propylene. In an embodiment, the polymer feed comprises at least one propylene component. In a preferred embodiment the polymer comprises at least 50 wt % propylene, preferably at least 60 wt % propylene, alternatively at least 70 wt % propylene, alternatively at least 80 wt % propylene based on the total weight of the polymer.

In still another embodiment of the invention, the polymer feed is substantially free of styrene. In an embodiment, the polymer feed has 5 wt % or less of styrene, or preferably 3 wt % or less of styrene, or more preferably 1 wt % or less of styrene based on the total weight of the polymer.

In a preferred embodiment of the invention, the polymer feed is molten. A molten polymer feed is polymer feed which is in a form capable of being extruded. A molten polymer feed can be in melt form, semi-solid form, substantially liquid form, or liquid form. A molten feed may flow suitably by gravity or under pressure when released in batch processing or continuous flow processing. Preferably, the polymer feed is in a molten form prior to being extruded, and the extruder is not being used to melt the polymer feed.

In a preferred embodiment, the polymer feed is one which is prone to undergo phase separation upon cooling. Preferably, the polymer feed is composed of two or more components, one or more of which undergo crystallization as the polymer cools. As the component crystallizes the polymer melt may lose homogeneity as the polymer component in the melt disperses and falls out of solution forming a phase separation. In one embodiment, the polymer feed comprises an isotactic-polypropylene component which crystallizes as the polymer feed is cooled. The crystallized isotactic-polypropylene component may form a highly viscous layer on the surface of the melt cooler (heat exchanger), impeding further heat transfer as the polymer feed is cooled.

In some embodiments, the polymer feed exhibits delayed crystallization during cooling, concurrent with pelletizing, or subsequent to pelletizing, e.g., during storage. Described more particularly, as the polymer feed is cooled, crystallization begins to form. However, without being limited by theory, it is believed that the rate that the polymer feed is cooled effects the rate of crystallization such that the faster the polymer feed is cooled the longer it will take to fully crystallize. This, so called, delayed crystallization phenomena may be seen throughout the polymer feed, throughout the polymer pellets, or as fractionated crystallization in only regions of the polymer feed or pellets. For example, the exterior of individual pellets may be cooled more rapidly than the pellet interior thereby resulting in fractionated crystallization on the surface of each pellet. On a preferred embodiment, the polymer feed is cooled very rapidly, i.e., quench cooling, in an underwater pelletizer or in a melt cooler. In such embodiments, fractionated crystallization is more readily observed, e.g., at the outer portion of the polymer feed along the melt cooler's walls. Thus, the entirety of the polymer feed may not cool at the same rate. The provided methods and apparatus reduce the detrimental effects of utilizing and pelletizing such difficult-to-pelletize materials.

In an embodiment, the polymer feed exhibits a sharp change in viscosity as the polymer feed approaches the polymer feed's crystallization temperature.

In an embodiment of the invention, the polymer feed has a measurable melt point and a ring and ball softening point as measured according to ASTM D6493. In a preferred embodiment, the ring and ball softening point of the polymer feed is greater than the crystallization point of the polymer feed as measured by ASTM E 794-06. Preferably, the ring and ball softening point is 10° C. or more above the crystallization temperature, or more preferably 20° C. or more above the crystallization temperature.

In another embodiment of the invention, the polymer feed comprises an amorphous polymer. The polymer feed can have an amorphous content of at least 50%, alternatively at least 60%, alternatively at least 70%, even alternatively between 50 and 99%. The percent of amorphous content is determined using Differential Scanning Calorimetry measurement according to ASTM E 794-06.

In yet another embodiment of the invention, the polymer feed comprises a polymer with a crystallinity of 50% or less, alternatively 40% or less, alternatively 30% or less, alternatively 20% or less, even alternatively between 10% and 30%. Percent crystallinity content is determined using Differential Scanning Calorimetry measurement according to ASTM E 794-06. In another embodiment, the polymer feed comprises a polymer with a percent crystallinity of between 5% and 60%, alternatively between 10% to 50%.

In an embodiment of the invention, the polymer feed has a heat of fusion (AH) of 100 J/g or less, preferably 90 J/g or less, or 70 J/g or less, or 60 J/g or less, or 50 J/g or less, or 40 J/g or less, or 30 J/g or less, or 20 J/g or less and greater than zero, or greater than 1 J/g, or greater than 10 J/g, or between 10 and 50 J/g. Heat of fusion is measured according to ASTM E 794-06.

In an embodiment of the invention, the polymer feed has a viscosity (also referred to as a Brookfield Viscosity or Melt Viscosity) at 190° C. of less than about 100,000 cP, but may be higher for some compositions. Preferably, polymer feeds have a viscosity at 190° C. of less than about 50,000 cP, or less than about 35,000 cP, or 30,000 cP, or less at 190° C.; or 25,000 cP or less at 190° C.; or 20,000 cP or less at 190° C.; or 15,000 cP or less at 190° C.; or 10,000 cP or less at 190° C.; or 8,000 cP or less at 190° C.; or 6,000 cP or less at 190° C.; or 5,000 cP or less at 190° C.; or 4,000 cP or less at 190° C.; or 3,000 cP or less at 190° C.; or 2,000 cP or less at 190° C.; or 1,000 cP or less at 190° C. as measured by ASTM D 3236 at 190° C. In another embodiment, the polymer feed has a viscosity in the range of from about 100 cP at 190° C. to about 35,000 cP at 190° C. In a further embodiment of the invention, the polymer feed has a viscosity of less than 35,000 cP at the polymer feed's process conditions; or 20,000 cP or less; or 15,000 cP or less; or 10,000 cP or less; or 5,000 cP or less; or 3,000 cP or less; or 2,000 cP or less; or 1,000 cP or less; or 900 cP or less; or 800 cP or less; or 700 cP or less; or 600 cP or less; 500 cP or less; or alternatively, from 100 cP to 35,000 cP, or from 500 cP to 20,000 cP; or from 800 cP to 15,000 cP. Preferably these viscosities are the viscosity of the polymer feed prior to entering either the melt cooler or the cooling extruder.

In an embodiment of the invention at least one component of the polymer feed has a weight average molecular weight (Mw) of less than 70,000 or less, alternately about 60,000 or less, alternately about 50,000 or less, or alternately about 40,000 or less. Alternately, at least one component of the polymer feed has a Mw in the range of from about 10,000 to about 70,000. The molecular weight is measured by using a Waters 150 SizeExclusion Chromatograph (SEC) equipped with a differential refractive index detector (DRI), an online low angle light scattering (LALLS) detector and a viscometer (VIS).

In a further embodiment of the invention, the polymer feed is substantially free of blowing agents. Substantially free of blowing agents is defined to mean that the polymer feed is largely, but not wholly, absent blowing agents. In some embodiments, small amounts of blowing agents may be present within the polymer feed as a result of standard manufacturing methods. In one embodiment “substantially free of blowing agents” means free of intentionally added blowing agents, in another embodiment it means free of any blowing agents. Blowing agents are generally either chemical blowing agents or physical blowing agents. Generally, chemical blowing agents undergo some form of chemical change (e.g., a chemical reaction with the polymer material at a predetermined temperature/pressure) that causes the release of a gas, such as nitrogen, carbon dioxide, or carbon monoxide. Generally, physical blowing agents are dissolved in the polymer material under pressure and then expand volumetrically when the pressure is removed. Blowing agents can include halocarbons, hydrocarbons, atmospheric gases, and combinations thereof. Non-limiting examples of blowing agents include dichlorodifluromethane (CFC-12); trichlorofluromethane (CFC-11); C₂-C₆ alkanes such as ethane, propane, butane, isobutane, pentane, isopentane, and hexane; carbon dioxide; argon; and nitrogen.

In another embodiment, the polymer feed is substantially free of gases. Substantially free of gases is defined to mean that the polymer feed is largely, but not wholly, absent gases. In some embodiments, small amounts of gases may be present within the polymer feed as a result of standard manufacturing methods. In one embodiment “substantially free of gas” means free of intentionally added gases, in another embodiment it means free of any gas. Gases include, but are not limited to, blowing agents, carbon dioxide (CO₂), and nitrogen (N₂).

In a preferred embodiment of the invention the polymer feed comprises a hot melt adhesive (HMA). Preferably the HMA is a polyolefin adhesive. Polyolefin adhesive compositions to be utilized in this invention may be, for example, the polyolefin adhesive compositions disclosed in U.S. Pat. No. 7,223,822 B1, U.S. Patent Application Pub. No. 2004/0127614 A1, U.S. Patent Application Pub. No. 2004/0138392 A1, U.S. Patent Application Pub. Nos. 2004/0220320 A1, 2004/0220336 A1, and 2004/0249046 A1, all incorporated herein by reference. Conventional methods and apparatus for preparing olefin compositions are disclosed in U.S. Pat. Nos. 4,054,632, 5,041,251, 5,403,528, 6,238,732 B1, 6,894,109 B1, EP Publication No. 0 410 914 B1, and PCT Publication No. WO 2007/064580 A2, each of which is herein incorporated by reference in its entirety.

In a preferred embodiment, the polymer feed comprises at least 50 mol % of one or more C₃ to C₄₀ olefins where the polymer has a Dot T-Peel of 1 Newton or more on Kraft paper; a Mw of 10,000 to 100,000; a branching index (g′) of from 0.4 to 0.98 measured at the Mz of the polymer when the polymer has a Mw of 10,000 to 70,000, or a branching index (g′) of from 0.4 to 0.95 measured at the Mz of the polymer when the polymer has a Mw of 10,000 to 100,000; a heat of fusion of 1 to 70 J/g; and a heptane insoluble fraction of 70 weight %or less, based upon the weight of the polymer, where the heptane insoluble fraction has branching index g′ of 0.9 or less as measured at the Mz of the polymer. The Mw and the z-average molecular weight (Mz) can be determined by using a Waters 150 SizeExclusion Chromatograph (SEC) equipped with a differential refractive index detector (DRI), an online low angle light scattering (LALLS) detector and a viscometer (VIS). The branching index (g′) is measured using SEC with an on-line viscometer (SEC-VIS) and is reported as g′ at each molecular weight in the SEC trace. The branching index g′ is defined as: g′=η_{b}/η₁, where η_{b} is the intrinsic viscosity of the branched polymer and η₁ is the intrinsic viscosity of a linear polymer of the same viscosity-averaged molecular weight as the branched polymer. As used herein, Dot T-Peel is determined according to ASTM D 1876, except that the specimen is produced by combining two 1 inch by 3 inch (2.54 cm×7.62 cm) Kraft paper substrate cut outs with a dot of adhesive with a volume that, when compressed under a 500 gram weight occupies about 1 square inch of area (1 inch=2.54 cm). Once made, all the specimens are pulled apart in side by side testing (at the rate of 2 inches per minute) by a device which records the destructive force being applied. The maximum force achieved for each sample tested was recorded and averaged, thus producing the average maximum force, which is reported as the Dot T-Peel.

In one embodiment of the invention, the polymer feed comprises at least one additive. The additive may comprise about 50% or less by weight of the total weight of the feed, or 40% or less by weight of the total weight of the feed, or 30% or less by weight of the total weight of the feed, or 20% or less by weight of the total weight of the feed, or 10% or less by weight of the total weight of the feed.

Additives useful in embodiments of this invention may be solid or liquid. The additives may be in the molten polymer feed before the polymer feed enters the extruder, or alternatively the additives may be added into the polymer feed as side injections into the extruder. Additives can be melted in a side-arm extruder, and then blended into the polymer. In one embodiment there may be one or more feeding and injection ports along the barrel of the extruder to allow for the addition of additives to the molten polymer feed. More than one additive may be incorporated into the polymer feed.

Useful additives can be chosen from the group consisting of: another polymer, fillers, antioxidants, adjuvants, adhesion promoters, tackifiers, waxes, oils, plasticizers, or the like, or mixtures thereof. Preferred additives include silicon dioxide, titanium dioxide, polydimethylsiloxane, talc, dyes, wax, calcium state, carbon black, low molecular weight resins, and glass beads. Other preferred additives include block, antiblock, pigments, processing aids, UV stabilizers, hindered amine light stabilizers, UV absorbers, neutralizers, lubricants, surfactants, and nucleating agents. Preferred fillers include, but are not limited to, titanium dioxide, calcium carbonate, barium sulfate, silica, silicon dioxide, carbon black, sand, glass beads, mineral aggregates, talc, clay, and the like. Preferred adhesion promoters include polar acids, polyaminoamides, urethanes, coupling agents, titanate esters, reactive acrylate monomers, metal acid salts, polyphenylene oxide, oxidized polyolefins, acid modified polyolefins, and preferably anhydride modified polyolefins. Preferred plasticizers include mineral oils, polybutenes, phthalates, and the like. Particularly preferred oils include aliphatic napthenic oils. Preferred waxes may include both polar and non-polar waxes, functionalized waxes, polypropylene waxes, polyethylene waxes, and wax modifiers.

### Cooling Extruder

In an embodiment of the invention, a cooling extruder is used to cool the polymer feed. As the polymer melt is cooled along the length of the extruder, the effective viscosity of the polymer melt increases as the melt's temperature is lowered. In a preferred embodiment the polymer feed is cooled down in order to raise the viscosity of the polymer feed to at least about 5,000 cP for pelletizing.

In a particularly preferred embodiment, a cooling extruder is used to provide efficient mixing of the polymer feed while at the same time providing controlled cooling of the molten material. The cooling extruder provides for precise control of the polymer melt's temperature as the melt arrives at the pelletizing die face. The cooling extruder also provides a way to homogenize and accurately control the temperature of the polymer feed so that homogeneous and uniform pellets of any size may be made. Preferably, the cooling extruder provides dispersive mixing of the polymer feed to eliminate any phase separation of the blended components of the polymer feed.

The cooling extruder comprises an inlet, a barrel, and an outlet. The inlet is where the polymer feed is introduced into the extruder. The polymer feed then travels down the extruder barrel, and out the extruder outlet.

In an embodiment of the invention, the extruder comprises a single screw. In another embodiment, the extruder comprises a double screw. In a further embodiment of the invention, the extruder is a co-rotating twin screw extruder. In an embodiment of the invention, the extruder has three or more screws. Alternatively, the extruder can have a ring design.

In another embodiment of the invention the extruder comprises at least one screw with continuous flights. In yet another embodiment of the invention, the extruder comprises at least one screw with discontinuous flights.

In one embodiment, a useful extruder may have a cooling barrel comprising a wall, at least one central shaft having a screw with flights, a screw speed (ν), a pitch angle (θ), a flight width (w), a screw height (h), an inner barrel diameter (D), a barrel length (L), a molten polymer feed rate (FR), and a clearance distance between the flight and the cooling barrel (δ).

In one embodiment the extruder has a clearance between the flight and the cooling barrel (δ) of about 0.0005 m to about 0.005 m, preferably the clearance is about 0.001 m. In an embodiment the extruder has a screw height (h) of about 0.004 m to about 0.02 m, preferably the screw height is about 0.01 m. In an embodiment the extruder has a pitch angle (θ) of about 40° to about 50°, preferably the pitch angle is about 45°. In an embodiment the extruder has a flight width (w) of about 0.1 m to about 0.3 m, preferably the flight width is about 0.2 m. In an embodiment the extruder has a screw speed (ν) of about 80 rpm to about 100 rpm, preferably the screw speed is about 90 rpm. As the screw speed increases the polymer feed may be heated, thus increasing the temperature of the polymer feed. Thus, it is preferred that the screw speed remain at such a speed so as to not heat the polymer feed causing the viscosity of the polymer feed to decreased so that the polymer feed can no longer be easily pelletized but yet remain at a high enough speed sufficient to develop the necessary pressure to drive the polymer feed through the pelletizing die.

In one embodiment the extruder has an inner barrel diameter (D) of about 80 mm to about 100 mm, preferably the barrel diameter is about 90 mm. In an embodiment the extruder has a barrel length (L) of about 5 m to about 6 m, preferably the length is about 5.5 m. In an embodiment the extruder has a length to diameter ratio (L/D) of about 50 to about 80, preferably the length to diameter ratio is about 60. In general, the cooling becomes less efficient as the melt progresses along the extruder, thus increasing the length of the extruder may not necessarily improve cooling capacity.

In one embodiment the feed rate (FR) of the polymer feed into the cooling extruder is from about 500 lb/hr to about 40,000 lb/hr, or from about 1000 lb/hr to about 30,000 lb/hr, or from about 2000 lb/hr to about 20,000 lb/hr. The feed rate of the polymer feed may vary greatly depending on the size of the apparatus being used. For example, for a pilot plant the feed rate may be less than 500 lb/hr; for a small plant the feed rate may be from about 1000 lb/hr to about 8000 lb/hr; for a large world scale plant facility the feed rate may be greater than 10,000 lb/hr, or even greater than 20,000 lb/hr.

Extruders useful in this invention include those commercially available from MARIS S.p.A., Century, Inc. of Traverse City, Mo., or Coperion Corporation of Ramsey, N.J., such as the Coperion ZSK-25 twin-screw extruder.

The extruder used in this invention may be used to provide a means for pressurizing and forwarding the polymer melt. In an embodiment the screw within the extruder can have sections with different numbers of flights. For example, the screw flights may be more closely spaced together near the extruder outlet in order to provide the desired pressure needed to force the polymer feed through the pelletizing die.

In another embodiment, the extruder creates at least 250 psi, or at least 300 psi, or at least 500 psi, or at least 1000 psi, or at least 2000 psi, or at least 3000 psi, or at least 4000 psi, or at least 5000 psi of driving force to drive the polymer feed through the pelletizing die. Alternatively, the extruder creates from about 250 to about 1000 psi of driving force, or more preferably from about 400 psi to about 1000 psi.

In an alternative embodiment, a melt pump may be used to create an additional driving force to forward the polymer feed through the pelletizing die. The melt pump may be located after the extruder. Alternatively, the melt pump may be located before the extruder. The melt pump may generate at least 200 psi of pressure on the polymer feed, more preferably from about 500 psi to about 2000 psi. The melt pump may be centrifugal, positive displacement, reciprocating, or rotary pump. Preferably, the melt pump is a rotary pump which may be peristaltic, vane, screw, lobe, or progressive cavity. Most preferably, the melt pump is a gear pump. The melt pump may be used as a booster pump to build on the pressure already created by the cooling extruder.

In one embodiment of the invention, the polymer feed is cooled as it moves down the barrel of the extruder. The cooling extruder provides a method for controlled cooling of the polymer feed, while providing efficient mixing of the polymer feed. The polymer may be cooled by a transfer of heat from the polymer feed through the extruder wall into a cooling medium.

In one embodiment a conventional cooling extruder with drilled cooling pathways may be used. A cooling medium may flow through the drilled cooling pathways to remove heat from the polymer feed. In another embodiment the extruder comprises a cylindrical tube and a second larger diameter cylindrical tube oriented coaxially to the extruder forming an outer cooling pathway around the extruder.

A cooling medium, such as water or any other material having a lower temperature than the feedstock in the extruder, may be used to cool the polymer feed. The cooling medium may pass through the cooling pathways and withdraw heat from the polymer feed. The temperature of the polymer feed can be modified by varying the flow rate and/or temperature of the cooling medium which passes through the extruder's cooling pathway.

In another embodiment the cooling medium can be in the extruder's screw shaft. An example of a useful extruder where the cooling medium can be found in the screw shaft can be found in U.S. Patent Application Publication No. 2005/0236734 A1, incorporated herein by reference.

In an embodiment of the invention, water is used as a cooling medium to remove heat from the barrel of the extruder. In another embodiment of the invention, water and glycol are used as a cooling medium to remove heat from the barrel of the extruder. In a further embodiment of the invention, cold gases can be used as a cooling medium to remove heat from the barrel of the extruder. Useful cold gases are carbon dioxide and propane. The cooling medium may be any medium which is a fluid suitable for heat dissipation, such as water, salt solutions, brine, ethylene glycol chilled water, or low-melting-point organic compounds.

In one embodiment the cooling medium temperature is about 50° F. or less, or about 45° F. or less, or about 40° F. or less, or about 35° F. or less. In another embodiment the cooling water temperature is from about 50° F. to about 55° F. Preferably the temperature of the cooling water is about 55° F.

In an embodiment the temperature of the polymer feed at the cooling extruder inlet is from about 220° F. to about 260° F. In an embodiment the temperature of the polymer feed at the cooling extruder outlet is from about 210° F. to about 230° F. In one embodiment the polymer feed is cooled so that the difference in the inlet temperature and the outlet temperature is at least 5° F., or at least 10° F., or at least 20° F., or at least 30° F., or at least 50° F. In another embodiment, the temperature of the polymer feed at the cooling extruder inlet is from about 160° F. to about 550° F., alternatively from about 200° F. to about 400° F., or from about 220° F. to about 260° F. The temperature of the polymer feed at the cooling extruder outlet may be from about 75° F. to about 400° F., or from about 100° F. to about 300° F., or from about 200° F. to about 250° F., or from about 210° F. to about 230° F.

The extruder screw can be used to mix and homogenize the polymer feed. The extruder may be used to mix and homogenize any crystallization or solid precipitation that may form in the polymer feed. The extruder can be used to enhance the dispersion of the materials in the polymer feed, thus eliminating any phase separation that may occur. The extruder can be used to keep the polymer components in solution. In an embodiment, the blades on the extruder screw may be used to wipe the walls of the extruder, thus preventing any crystallization from forming on the extruder walls.

In a preferred embodiment, the temperature of the polymer feed at the extruder outlet is less than the ball-and-ring softening temperature of the polymer feed yet greater than the crystallization temperature of the polymer feed.

In an alternate embodiment, the extruder is operating at an outlet temperature less than the crystallization temperature of the polymer feed, but the viscosity of the polymer feed remains sufficiently high to produce pellets. In an embodiment the extruder is operating at an outlet temperature less than the crystallization temperature of the polymer feed but the viscosity of the polymer feed is at least 5000 cP at 190° C. In an embodiment of the invention, the extruder is operating at an outlet temperature less than the crystallization temperature of the polymer feed. In an embodiment the molten polymer feed is cooled to a temperature below the crystallization temperature of the polymer feed. The outlet temperature may be 1° C. or more, 5° C. or more, or 10° C. or more, or 20° C. or more lower than the crystallization temperature of the polymer feed.

In a further embodiment, two or more cooling extruders may be used in parallel to cool the polymer melt prior to extrusion. A useful example of using two extruders in parallel can be found in U.S. Patent Application Publication No. 2003/0094718 A1, incorporated herein by reference. In another embodiment, two or more cooling extruders may be used in series to cool the polymer melt.

In an embodiment of the invention, the method and apparatus further comprise the use of a heat exchanger. A heat exchanger, e.g., melt cooler, can be used to cool the polymer feed before the polymer feed enters the extruder. Alternatively, a heat exchange can be used to further cool the polymer feed after the polymer feed exits the extruder. The heat exchanger may be a melt cooler of the coil type, scrape wall, plate and frame, shell or tube design with or without static mixers. Preferably a shell and tube design melt cooler which includes static mixing blades within the individual tubes is used.

### Underwater Pelletizer

The cooled extruded polymer feed is pelletized. Pelletization of the polymer feed may be by an underwater, hot face, strand, water ring, or other similar pelletizer. Preferably an underwater pelletizer is used, but other equivalent pelletizing units known to those skilled in the art may also be used. General techniques for underwater pelletizing are known to those of ordinary skill in the art. Examples of useful underwater pelletizing devices can be found in U.S. Pat. Nos. 7,033,152 B2, 7,226,553 B2, and U.S. Patent Application Publication No. 2007/0119286 A1, all incorporated herein by reference.

In one embodiment an underwater pelletizer is used to pelletize the cooled extruded polymer feed. The cooled polymer feed is extruded through a pelletizing die to form strands. The strands are then cut by rotating cutter blades in the water box of the underwater pelletizer. Water continuously flows through the water box to further cool and solidify the pellets and carry the pellets out of the underwater pelletizer's water box for further processing.

In one embodiment, the pelletizing die is thermally regulated by means known to those skilled in the art in order to prevent die hole freeze-off.

In an embodiment the underwater pelletizer uses chilled water, thus allowing for further rapid cooling of the pellets and solidification of the outermost layer of the pellets. In an embodiment, the temperature of the water in the underwater pelletizing unit may be from about 35° F. to about 75° F. Preferably a water chilling system is able to cool the water going to the underwater pelletizer water box (cutting chamber) down to about 40° F.

In an embodiment, the underwater pelletizer unit has a chilled water slurry circulation loop. The chilled water helps eliminate the tendency of the pellets to stick together and allows the extruded polymer strands to be more cleanly cut. The chilled water slurry circulation loop extends from the underwater pelletizer, carrying the pellet-water slurry to a pellet drying unit, and then recycles the water back to the underwater pelletizer.

In an embodiment, the residence time of the pellets in the chilled water slurry circulation loop is at least 10 seconds, or at least 20 seconds, or at least 30 seconds, or preferably at least 40 seconds, or at least 50 seconds or more. As fresh pellets tend to bridge and agglomerate if the pellets have not had adequate time to crystallize and harden, or if the polymer is a low crystallinity polymer, it is preferred that the pellets have sufficient residence time in the pellet water loop.

In another embodiment chilled water removes the pellets from the cutter blade and transports them through a screen which catches and removes coarsely aggregated or agglomerated pellets. The water then transports the pellets through a dewatering device and into a centrifugal dryer or fluidized bed to remove excess surface moisture from the pellets. The pellets may then pass through a discharge chute for collection or may proceed to additional processing including which can include pellet coating, crystallization, or further cooling as required to achieve the desired product.

The pelletizing die can be used to make pellets in shapes not limited to spheres, rods, slats, or polygons. Preferably, near spherical pellets are made. A pellet shape that will allow the pellets to easily flow is preferred.

The speed at which the pelletizer operates is selected according to the die plate size, number of orifices in the die, and to achieve the desired pellet size and shape. The number of orifices in the die and the orifice geometry are selected as appropriate for the polymer feed flow rate and melt material as is known to those skilled in the art.

Optionally, an antiblocking agent may be added to the water in the underwater pelletizing water box or chilled water slurry loop. The addition of an antiblock to the pellet water loop is useful to prevent pellets from sticking together in the loop and plugging the lump catcher screen upstream of the dryer.

The temperature of the water, the rotation rate of the cutter blades, and the flow rate of the polymer melt through the pelletizing die all contribute to the production of proper pellet geometries. Additionally, the temperature of the pellets, both in the interior and the exterior, also influence the formation of the pellets as well as the drying of the pellets.

Incomplete crystallization of the polymer material in the pellets after the pellets have exited the pellet-water slurry loop can lead to poor pellet geometry, pellet deformation, and reduced ability of the pellets to freely flow. The degree of crystallization of the pellets is affected by residence time and temperature of the pellets. Additionally, the pellet hardness varies with residence time and temperature.

### Drying

In an embodiment of the invention, the pellets are dried after exiting the underwater pelletizing unit. Drying can be by any process, including centrifuge, fluid bed drier in which a heated gas (e.g., air) is passed through a fluidized bed of the pellets, or a flash dryer. Preferably, the pellets are dried in a centrifugal dryer, which is connected to the outlet of the underwater pelletizing die. Examples of useful centrifugal driers are those available from Gala Industries, such as those disclosed in U.S. Pat. Nos. 6,807,748 B2; 7,024,794 B1; and 7,171,762 B2, all incorporated herein by reference.

In one embodiment, the pellet-water slurry passes through an agglomerate catcher which may comprise a round wire grid or coarse screen to remove oversize chunks or agglomerates of pellets. The pellet-water slurry may then optionally pass through a dewatering device, or a series of dewatering devices, containing baffles and an angular feed screen which collectively reduce the water content, preferably 90% or more, or 98% or more. The removed water may then pass through a fines removal screen into a water tank/reservoir so that it may be recycled or disposed. The pellets may then pass through a centrifugal dryer to remove any remaining water. The dried pellets then exit the centrifugal dryer and proceed to storage or may be further processed with coatings, additional crystallization or further cooled as is well understood by those skilled in the art.

In another embodiment, after the pellets exit the centrifugal dryer they proceed to a further drying step to eliminate any excess moisture. The further drying step may be a fluid bed dryer or another means of drying known to those of ordinary skill in the art.

Desirably the pellets are dry when they are packaged. The pellets are considered to be dry when they comprise less than 1 wt % moisture, or less than 0.5 wt % moisture, or less than 0.1 wt % moisture, or most preferably less than 0.08 wt % moisture. It may be necessary to warm the pellets before packaging so that the cold pellets will not collect condensation from atmospheric moisture. The warming and drying step and the crystallization step may occur at the same time in the same piece of equipment.

### Additional Processing

After drying the pellets may be collected and batched or, alternatively, may proceed for additional processing such as further cooling or dusting/coating.

In one embodiment, the pellets are dusted/coated with an external antiblock. An external antiblock can be used to allow for easy flow of pellets through packaging equipment and to prevent agglomeration in the final package. Any antiblock known to be compatible with the polymer pellet may be used. Preferably the pellets are dusted with the antiblock by mechanical mixing, so that a consistent even coating of antiblock is formed on the pellet surface. Mechanical mixing of the pellets and antiblock allows for good antiblock coverage on the pellets and good adhesion/embedding of antiblock particles on the pellets.

### End Uses

Polymers used in this invention may be useful as adhesives, viscosity modifiers, meltblown or spunbond non-wovens, packaging HMAs, or polypropylene blending additives.

The adhesives of this invention can be used in any adhesive application, including but not limited to, disposables, packaging, laminates, pressure sensitive adhesives, tapes, labels, wood binding, paper binding, non-wovens, road marking, reflective coatings, and the like. The adhesives described above may be applied to any substrate. In a particular embodiment, the adhesives of this invention can be used in a packaging article.

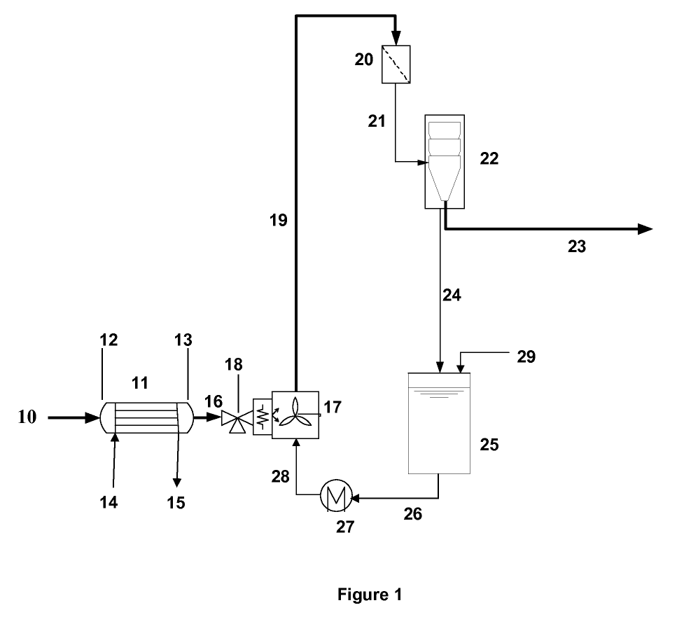

An embodiment of the invention will now be more particularly described with reference to the figures. FIG. 1 is a schematic illustration of a conventional apparatus for pelletizing a polymer feed, wherein the apparatus comprises a melt cooler, an underwater pelletizer, and a drying apparatus. Referring to FIG. 1, the molten polymer feed travels from a storage tank (not shown) or other polymer feed source (not shown) through conduit 10 and enters the melt cooler 11 at the melt cooler inlet 12. The polymer feed is cooled as it is moves through the melt cooler, moving from the melt cooler inlet 12 to the melt cooler outlet 13. Cooling medium flows through a cooling jacket (not shown) around the melt cooler 11 flowing from the cooling medium inlet 14 to the cooling medium outlet 15.

The cooled polymer feed exits the melt cooler 11 through the melt cooler outlet 13 and travels through conduit 16 into the underwater pelletizer 17. Optionally, the polymer feed may travel through diverter valve 18 before entering the underwater pelletizer 17. The diverter valve 18 can be used to divert the polymer feed from the cooling/pelletizing processing line to be recirculated or purged/discharged from the apparatus. This can be particularly useful when cleaning the cooling/pelletizing processing line. Conduit 16 may be long or short. Alternatively, there is no conduit 16 and the polymer feed travels directly from the melt cooler outlet 13 into the diverter valve or into the underwater pelletizer 17.

The underwater pelletizer 17 cuts the cooled polymer feed to form pellets. The pellets then travel in a pellet-water slurry from the underwater pelletizer 17 through conduit 19 into catch screen 20. Catch screen 20 can be used to collect agglomerated pellets. The pellet-water slurry then travels through conduit 21 into the centrifugal drier 22, where the pellets are separated from the water and dried. In an alternate embodiment, there is no catch screen 20 or conduit 21 and the pellet-water slurry travels directly from the underwater pelletizer 17 through conduit 19 directly into the centrifugal drier 22.

The dried pellets then exit the centrifugal drier 22 through conduit 23, where they can proceed for further processing or be collected and packaged. The water separated from the pellets in the centrifugal drier 22 can then travel through conduit 24 into water storage tank 25, to be recycled back into the underwater pelletizer 17.

The water in the underwater pelletizer 17 is supplied from water storage tank 25. Water flows from the storage tank 25 through conduit 26 into a water cooler 27. Then the cooled water travels through conduit 28 into the underwater pelletizer 17. Alternatively, there is no water cooler 27 and water flows directly from the storage tank 25 through conduit 26 into the underwater pelletizer 17. Optionally, anti-block additives may be added into the water in the water storage tank 25 through conduit 29.

In an embodiment, not shown, water from the storage tank 25 can travel through conduit 26 into a water cooler 27, and through a conduit (not shown) into the melt cooler's 11 cooling jacket to act as the cooling medium. The cooled water can enter the cooling jacket through the cooling medium inlet 14 and exit the cooling jacket through the cooling medium outlet 15, where it can then be recycled back to the water storage tank 25 to be re-cooled.

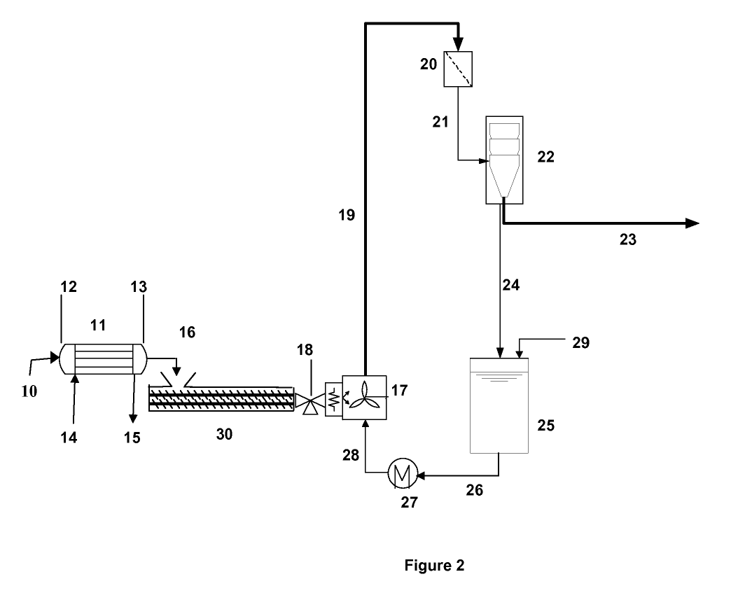

FIG. 2 is a schematic illustration of an embodiment of the inventive apparatus for pelletizing a polymer feed, wherein the apparatus comprises a melt cooler, a cooling extruder, an underwater pelletizer, and a drying apparatus. Some equipment in FIG. 2 is similar to that in FIG. 1, e.g., the melt cooler, the underwater pelletizer, and the drying apparatus, and as such have been described using the same identifying numerals. Referring to FIG. 2, the molten polymer feed travels from a storage tank (not shown) or other polymer feed source (not shown) through conduit 10 and enters the melt cooler 11 at the melt cooler inlet 12. The polymer feed is cooled as it is moves through the melt cooler, moving from the melt cooler inlet 12 to the melt cooler outlet 13. Cooling medium flows through a cooling jacket (not shown) around the melt cooler 11 flowing from the cooling medium inlet 14 to the cooling medium outlet 15.

The cooled polymer feed exits the melt cooler 11 through the melt cooler outlet 13 and travels through conduit 16 into the cooling extruder 30. Conduit 16 may be long or short. Alternatively there is no conduit 16 and the polymer feed travels directly from the melt cooler outlet 13 into the cooling extruder 30. The cooling extruder 30 cools the polymer feed as the polymer feed moves from the cooling extruder inlet along the length of the cooling extruder barrel and out the cooling extruder outlet. The cooling extruder 30 may be a twin screw extruder.

The cooled extruded polymer feed then exits the cooling extruder 30 and enters the underwater pelletizer 17. Optionally, the polymer feed may travel through diverter valve 18 before entering the underwater pelletizer 17. The diverter valve can be used to divert the polymer feed from the cooling/pelletizing processing line to be recirculated or purged/discharged from the apparatus. This can be particularly useful when cleaning the cooling/pelletizing processing line.

The underwater pelletizer 17 cuts the cooled extruded polymer feed to form pellets. The pellets then travel in a pellet-water slurry from the underwater pelletizer 17 through conduit 19 into catch screen 20. Catch screen 20 can be used to collect agglomerated pellets. The pellet-water slurry then travels through conduit 21 into the centrifugal drier 22, where the pellets are separated from the water and dried. In an alternate embodiment, there is no catch screen 20 or conduit 21 and the pellet-water slurry travels directly from the underwater pelletizer 17 through conduit 19 directly into the centrifugal drier 22.

The dried pellets then exit the centrifugal drier 22 through conduit 23, where they can proceed for further processing or be collected and packaged. The water separated from the pellets in the centrifugal drier 22 can then travel through conduit 24 into water storage tank 25, to be recycled back into the underwater pelletizer 17.

The water in the underwater pelletizer 17 is supplied from water storage tank 25. Water flows from the storage tank 25 through conduit 26 into a water cooler 27. Then the cooled water travels through conduit 28 into the underwater pelletizer 17. Alternatively, there is no water cooler 27 and water flows directly from the storage tank 25 through conduit 26 into the underwater pelletizer 17. Optionally, anti-block additives may be added into the water in the water storage tank 25 through conduit 29.

In an embodiment, not shown, water from the storage tank 25 can travel through conduit 26 into a water cooler 27, and through a conduit (not shown) into the melt cooler's 11 cooling jacket to act as the cooling medium. The cooled water would enter the cooling jacket through the cooling medium inlet 14 and exit the cooling jacket through the cooling medium outlet 15, where it can then be recycled back to the water storage tank 25 to be re-cooled.

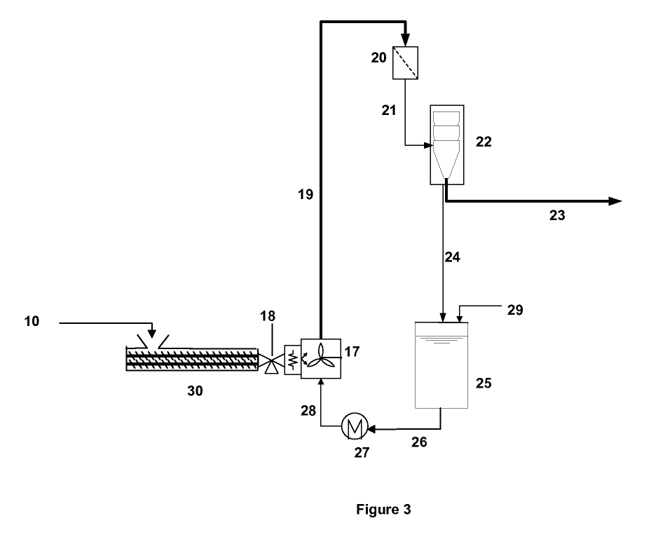

FIG. 3 is a schematic illustration of an apparatus for pelletizing a polymer feed composed of an extruder, an underwater pelletizer, and a drying apparatus. This embodiment is similar to the embodiment shown in FIG. 1, except that the melt cooler 11 is replaced with only an extruder.

While the illustrative embodiments have been described with particularity, it will be understood that various other modifications will be apparent to and can be readily made by those skilled in the art without departing from the spirit and scope of the invention. To the extent that this description is specific, it is solely for the purposes of illustrating certain embodiments of the invention and should not be taken as limiting the present inventive concepts to these specific embodiments. Accordingly, it in not intended that the scope of the claims appended hereto be limited to the examples and descriptions set forth herein but rather that the claims should be construed as encompassing all the features of patentable novelty which reside in the present invention, including all features which would be treated as equivalents thereof by those skilled in the art to which the invention pertains.

### EXAMPLES

The method and apparatus for pelletizing a polymer feed will now be further described with reference to the following non-limiting examples.

In Examples 1-3 the polymer melt was composed of a hot melt adhesive (HMA). The HMA comprised 86.1 wt % of a metallocene catalyzed mixed-tacticity polypropylene polymer having a DSC heat of fusion of from about 30 J/g to about 40 J/g and a melting temperature of from about 130° C. to about 135° C.; 7.0 wt % of PARAFLINT® C80, commercially available from Schumann Sasol, Ltd.; 3.5 wt % of ESCOREZ® 5300, commercially available from ExxonMobil Chemical Company in Baytown, Tex.; 2.0 wt % of MAPP 40, commercially available from Chusei of the USA; and 1.4 wt % of an anti-oxidant.

The HMA has a melting temperature by DSC of 130-135° C.; an onset of crystallization of 90-100° C. as measured by DSC; a viscosity at 177° C. of 800-900 cP; a viscosity at 160° C. of 1300-1400 cP; a Shore A hardness of 80-85; and a softening point of 135-140° C. The difference between the HMA's melting temperature of from about 130° C. to about 135° C. and the HMA's crystallization temperature of from about 90° C. to about 100° C. is due to a delayed crystallization of the HMA at the DSC method prescribed cooling rate.

As the HMA melt approaches the melting temperature crystallization begins to form and the viscosity curve rises steeply. This corresponds in a change from a clear melt to a cloudy one. Further cooling of the melt completes the transition to an opaque solid. The HMA's viscosity curve rises sharply near the melting point where shear-induced crystallization begins to occur.

### Example 1

In this example, the polymer feed was pelletized using a gear pump-melt cooler-pelletizer configuration. The melt-cooler-pelletizer configuration was similar to that shown in FIG. 1. A conventional gear pump was used to force the polymer feed through the melt cooler and the underwater pelletizer. A conventional melt cooler was used to cool the polymer feed and a conventional underwater pelletizer was used to pelletize the polymer feed. After the polymer feed was pelletized, the pellets were dried in conventional centrifugal dryer.

Pelletizer run conditions for the five test runs of Example 1 can be found in Table 1. Test Nos. 1, 2, and 3 utilized a standard 3-blade cutter. Test Nos. 4 and 5 used a 4-blade cutter. In Test No. 1, no wrap-ups around the cutter assembly were observed, however pellets slowly agglomerated at the dryer discharge. In Test No. 2, the cutter current rose to 2 amps and then polymer wrap-ups occurred around the pelletizer every three to four minutes. In Test No. 3, new cutter blades were used, and no wrap-ups were observed during 1.5 hours of operation. In Test No. 4, wrap-ups began to occur after several minutes of operation, and the cutter current draw rose to 2 amps before the wrap-ups. In Test No. 5, there were no wrap-ups observed during 1.5-2 hours of operation.

During the underwater pelletizer operation, the cutter blades were constantly being sharpened against the die plate. While the blades stayed sharp, they become worn and were literally shortened in length. This in turn affected the blade-die contact and cutability of “extrudates” lacking strength, especially where the viscosity of the extrudate was less than 1,200 cP at 190° C. Thus, when pelletizing the extrudates with a viscosity of less than 1,200 cP at 190° C. cutter blades with less than 80% wear were needed. This is demonstrated in a comparison of Test No. 3 where new cutter blades were used and no wrap-ups occurred, versus Test No. 2 where the blades were worn from the prior Tests and wrap-ups frequently occurred.

The water temperature in the underwater pelletizer needed to be as low as 33-34° F. (about 1° C.) in order to pelletize the HMA products with a viscosity less than 800 cP. In Test No. 4 warmer water was used and cutter wrap-ups quickly began to occur. It is believed that the lower the water temperature, the stronger the quenched extrudates are. However, one risk of using low water temperatures is die-hole freeze off.

By extending the pellet residence time in water, e.g., by extending the water-slurry piping length, the agglomeration of softer pellets (e.g., pellets where the polymer crystallinity was less than 30 J/g) in the dryer discharge was reduced.

Despite improved performance with colder pelletizer water, and use of low wear cutter blades, the test runs in Example 1 were often accompanied with slow crystallization on the melt cooler tube walls. The accumulated crystallization on the melt cooler tube walls resulted in a loss of heat transfer efficiency, which in turn caused the melt temperature exiting the cooler to rise and the melt viscosity through the die holes to drop. With increasingly stringent viscosity targets, e.g., polymer feeds with viscosities less than 800 cP at 190° C., loss of cooling performance often translated to start of wrap-ups in the pelletizer. Thus, with the cutter wrap-ups and the fouled melt cooler, pelletizing with the gear pump-melt cooler-pelletizer configuration was difficult.

TABLE 1

| | Test No: | | | | |
|---|---|---|---|---|---|
| | 1 | 2 | 3 | 4 | 5 |
| Polymer Feed Melt | 1300 | 1000 | 900 | 800 | 800 |
| Viscosity at 190° C. | | | | | |
| Polymer Feed ΔH (J/g) | 26 | 28 | 28 | 36 | 36 |
| % wax (C80 + MAPP) | 0 + 0 | 10 + 0 | 10 + 0 | 7 + 2 | 7 + 2 |
| Melt feed rate (lb/hr) | 26 | 30 | 30 | 30 | 26 |
| Die hole size/no. | 0.110″/2 | 0.110″/2 | 0.110″/2 | 0.110″/2 | 0.110″/1 |
| Die temperature (F.) | 260 | 260 | 260 | 260 | 260 |
| Die pressure drop (psi) | 400 | 250 | 250 | 250 | 400 |
| Melt temperature (F.) | 251 | 260 | 272 | 271 | 271 |
| Water temperature (F.) | 37-39 | 38-40 | 50 | 50 | 33 |
| Cutter rpm | 3000 | 3000 | 3000 | 3000 | 3000 |
| Cutter amps | 0.6 | 0.6 (cutter | 0.7 | 0.7 (cutter | 0.7 |
| | | currant draw | | currant draw | |
| | | rose to 2 amps | | rose to 2 amps | |
| | | before wrap-up) | | before | |
| | | | | wrap-up) | |

### Example 2

In this example an apparatus similar to that of Example 1 was used, except that a larger multi-tube melt cooler exchanger was used that had a higher heat transfer fluid temperature. A conventional gear pump was used to force the polymer feed through the melt cooler and the underwater pelletizer. A multi-tube melt cooler was used to cool the polymer feed and a conventional underwater pelletizer was used to pelletize the polymer feed. After the polymer feed was pelletized, the pellets were dried in conventional centrifugal dryer.

Pelletizer run conditions for the four test runs of Example 2 are found in Table 2. In Tests No. 1, 2, and 3, a shell and tube heat exchanger with 13 tubes (having 0.5″ static mixer elements inside) was used. In Test No. 4, the same melt cooler was used as for Tests Nos. 1-3; however, the outer 6 of the 13 tubes were plugged.

In Test Nos. 1 and 2 the temperature of the adhesive coming out of the melt cooler slowly rose during the pelletizing run. In Test No. 1 the pelletizer ran for 2 hours and then cutter wrap-ups formed and the pelletizer could not be restarted. In Test No. 2 the pelletizer ran for 2 hours with two trouble-free re-starts during the 2 hour period, but after the 2 hour period cutter wrap-ups formed and the pelletizer performance could not be repeated. In Test No. 3, the pelletizer ran for 3.5 hours with no cutter wrap-ups. In Test No. 4, the pelletizer ran for 1.5 hours with one trouble-free restart during the 1.5 hour period, but after the 1.5 hour period the pelletizer performance could not be repeated.

In Example 2, the optimum melt feed rate was 25-27 lb/hr/hole. When the melt feed rate was increased to 30 lb/hr/hole, as in Test No. 4, cutter wrap-ups occurred. Additionally, cutter rpm had to be maintained at a high rate. When the cutter speed was reduced from 3000 rpm to 750 rpm in Test 4 this led to cutter wrap-ups. The use of a continuous hole profile and the 750 cutter appeared to improve cutting performance, as compared to using standard 450 blades in Test No. 1 where cutter-wrap ups were observed.

However, even with the larger melt cooler used in Example 2 as compared to Example 1, the build up of crystallized polymer on the tube walls was not prevented. Even at apparent optimum conditions, the pelletizer was unable to handle polymer melts with lower viscosities and in order to prevent partial crystallization on the melt cooler tubes the melt cooler was had to operate at a higher temperature.

TABLE 2

| | Test No.: | | | |
|---|---|---|---|---|
| | 1 | 2 | 3 | 4 |
| Melt Feed rate | 50 | 158 | 30 | 100 |
| (lb/hr) | | | | |
| Die hole | 0.125″/2 | 0.110″/4 | 0.110″/1 | 0.110″/4 |
| size/no. | | | | |
| Die design | Standard | Continuous | Continuous | Continuous |
| | land. | hole. | hole. | hole. |
| Cutter type/no. | Standard | 75°/6 | 75°/8 | 75°/6 |
| of blades | (45°)/4 | | | |
| Die | 300 | 275 | 300 | 280 |
| temperature | | | | |
| (F.) | | | | |
| Die pressure | 300 | 275 | 300 | 280 |
| drop (psi) | | | | |
| Melt | 230 → 241 | 258 → 269 | 268 | 250 |
| temperature | | | | |
| (F.) | | | | |
| Melt cooler oil | 226/227 | 248/250 | 260/261 | 243/241 |
| temperature in/ | | | | |
| out (F.) | | | | |
| Water | 40 | 35 | 35 | 37 |
| temperature | | | | |
| (F.) | | | | |
| Cutter rpm | 1000 | 2000 | 3000 | 3000 |

### Example 3

In Example 3 adhesive pellets were made by cooling the polymer feed in a cooling extruder and using the extruder's pressure to drive the feed through the pelletizer. In this example the extruder used was the Coperion ZSK-25 twin-screw extruder which is commercially available from Coperion Corporation of Ramsey, N.J. A conventional underwater pelletizer and drying apparatus were used. Test run conditions for the two test runs of Example 3 are found in Table 3.

In Test No. 1, adhesive pellets were fed to the twin-screw extruder, melted, and cooled to 106° C. to form a paste to be pelletized. During two days of operation no wrap-ups or pellet quality issues were encountered.

In Test No. 2 an adhesive melt was fed to the extruder, cooled, and then pelletized. Additionally, in Test No. 2, the screw flights on the extruder screw were arranged with wide flights directly under the melt feed port (extruder inlet) and the flights transitioned to close flights by the discharge zone (extruder outlet) by the pelletizing die. For pelletizing the melt fed extruder, the demonstrated heat transfer coefficient for barrel cooling was calculated to be 31 Btu/hr-F-ft².

The pellets produced in Example 3 were homogeneous, suggesting that the crystallized components were readily dispersed under the shear forces of the extruder.

TABLE 3

| | Test No: | |
|---|---|---|
| | 1 | 2 |
| Feed type/temperature | Solids/ambient | Melt/300° F. |
| Feed Rate (lb/hr) | 80 | 80 |
| Extruder speed (rpm) | 360 | 300 |
| Extruder drive torque (%) | 40 | 24 |
| Extruder barrel temperature | 176 | 111 |
| (F.) | | |
| Die hole size/no | 0.125″/2 | 0.110″/4 |
| Die design | Standard land | Standard land |
| Cutter type/no. of blades | Standard (45°)/4 | Standard (45°)/6 |
| Die temperature (F.) | 280 | 280 |
| Die pressure drop (psi) | 710 | 350 |
| Melt temperature (F.) | 220 | 163 |
| Water temperature (F.) | 45 | 37 |
| Cutter rpm | 2000 | 3000 |

Comparing the pellets formed in Examples 1, 2, and 3, it could be seen that in Examples 1 and 2 cooling by a melt cooler alone, allowed some crystallization and phase separation to occur with in the melt which in turn led to the production of non-uniform and non-homogenous pellets. There was not sufficient dispersive mixing of the polymer feed with the melt cooler alone to produce uniform and homogeneous pellets. Additionally, as the polymer feed crystallized within the melt cooler, crystallization formed on the melt cooler walls leading to a loss of heat transfer and reduced cooling of the polymer feed. This in turn led to polymer wrap ups around the cutter assembly and poor pellet formation.

In Example 3 using a cooling extruder allowed for sufficient dispersive mixing of the polymer feed to eliminate phase separation of the blended materials in the polymer feed. The cooling extruder caused rigorous mixing and propagation of the polymer feed maximizing the dispersive homogeneity of the melt. This allowed for the formation of uniform and homogenous pellets.

### Example 4

In Example 4 adhesive pellets were made by cooling a molten adhesive feed in a melt cooler followed by further cooling and pressurization in a cooling extruder. Pressure for extrusion through the die was provided by the cooling extruder. The cooling extruder was a Maris 92 mm twin-screw extruder which is commercially available from MARIS S.p.A. The pelletizer was a standard underwater pelletizer commercially available from GALA Industries, Inc. of Eagle Rock, Va.

Three hot melt adhesive polymer feeds were successfully pelletized in large quantities. The adhesives melts were those described in U.S. Patent Application Publication 2004/0138392 A1. Properties of the hot melt adhesive polymer feeds used can be found in Table 4.

As seen in Table 5, for HMA A and HMA B the temperature of the polymer melt at the outlet of the melt cooler was significantly below that of the softening point of the adhesive. The cooling extruder further reduced the polymer melt temperature, thus the polymer melt's temperature at the diverter valve following the cooling extruder approached the crystallization temperature of the HMA.

Thus, by precisely cooling the polymer melt in the cooling extruder to a temperature that was less than the softening point of the polymer melt but greater than the crystallization temperature, the polymer feeds were able to be easily pelletized. Additionally, the cooling extruder mixed and maintained the homogeneity of the polymer feed allowing uniform pellets to be formed. Thus, by using a cooling extruder the temperature of the polymer feed was able to be precisely controlled to an optimum temperature where the feed was easily pelletized yet uniformly dispersed.

TABLE 4

| | Softening Point | Crystallization | Viscosity (cP @ |
|---|---|---|---|
| Adhesive | (C) | Temp (C.) | 177° C.) |
| HMA A | 133 | 91 | 950 |
| HMA B | 132 | 66 | 950 |
| HMA C | 126 | 36 | 13,000 |

TABLE 5

| | Melt | | | |
|---|---|---|---|---|
| | Cooler | | Melt Cooler | |
| | Outlet | Diverter | Inlet Pressure | Die Face Pressure |
| Adhesive | Temp (C.) | Temp (C.) | (PSI) | (PSI) |
| HMA A | 115 | 103 | 84 | 719 |
| HMA B | 125 | 95 | 97 | 671 |
| HMA C | 134 | 103 | 343 | 797 |

What we claim is:

1. A method for pelletizing a molten polymer feed having a viscosity of less than 35,000 cP at 190° C., comprising:
(a) introducing the molten polymer feed into an extruder;
(b) cooling the molten polymer feed while in the extruder to raise the viscosity of the polymer feed to at least 5000 cP; and
(c) extruding the cooled polymer feed through a pelletizing die.

2. The method of claim 1 wherein the polymer feed is substantially free of blowing agents.

3. The method of claim 1 wherein the polymer feed comprises at least one propylene component.

4. The method of claim 1 wherein the polymer feed is substantially free of styrene.

5. The method of claim 1 wherein the polymer feed comprises at least 50 mol % of one or more C₃ to C₄₀ olefins where the polymer has
(a) a Dot T-Peel of 1 Newton or more on Kraft paper;
(b) a Mw of 10,000 to 100,000;
(c) a branching index (g′) of from 0.4 to 0.98 measured at the Mz of the polymer when the polymer has a Mw of 10,000 to 70,000, or a branching index (g′) of from 0.4 to 0.95 measured at the Mz of the polymer when the polymer has a Mw of 10,000 to 100,000;
(d) a heat of fusion of 1 to 70 J/g; and
(e) a heptane insoluble fraction of 70 weight % or less, based upon the weight of the polymer, where the heptane insoluble fraction has branching index (g′) of 0.9 or less as measured at the Mz of the polymer.

6. The method of claim 1 wherein the polymer feed comprises at least one additive chosen from the group comprising an antioxidant, tackifier, wax, oil, or plasticizer.

7. The method of claim 6 wherein the additive comprises about 50% or less of the total weight of the polymer feed.

8. The method of claim 1 wherein the extruder comprises a single screw or a double screw.

9. The method of claim 1 wherein the polymer feed has a heat of fusion (AH) less than 90 J/g.

10. The method of claim 1 wherein at least one component of the polymer feed has a Mw of less than 70,000.

11. The method of claim 1 wherein the extruder generates at least 250 psi of driving force.

12. The method of claim 1 wherein the extruder is operating at an outlet temperature less than the ring and ball softening temperature of the polymer feed and greater than the crystallization temperature of the polymer feed.

13. An apparatus for pelletizing a polymer feed, comprising:
(a) an extruder comprising an inlet, a barrel, and an outlet;
(b) a heat removing device adapted to remove heat from the barrel of the extruder; and
(c) an underwater pelletizing die attached to the outlet of the extruder;
wherein the polymer feed flows through the extruder barrel and the heat removing device removes heat from the polymer feed to raise the viscosity of the polymer feed to at least 5000 cP.

14. The apparatus of claim 13 further comprising a centrifugal dryer, wherein the centrifugal dryer is attached to the outlet of the underwater pelletizing die.

15. The apparatus of claim 13 wherein the extruder is a co-rotating twin screw extruder.

16. The apparatus of claim 13 wherein the extruder generates at least 250 psi of driving force.

17. The apparatus of claim 13 wherein the extruder is operating at an outlet temperature less than the ring and ball softening point but equal to or above the crystallization temperature of the polymer feed.

18. A method for pelletizing a molten polymer feed, having a viscosity at 190° C. of less than 35,000 cP, the method comprising:
(a) introducing the molten polymer feed into an extruder;
(b) cooling the molten polymer feed while in the extruder to raise the viscosity of the polymer feed to greater than 5000 cP; and
(c) extruding the cooled polymer feed through a pelletizing die;
wherein the polymer feed is cooled to a temperature less than the ring and ball softening point of the polymer feed but greater than the crystallization temperature of the polymer feed while in the extruder.

19. The method of claim 18, wherein the extruder generates at least 250 psi of driving force.

20. A method for pelletizing a molten polymer feed having a viscosity of less than 35,000 cP at 190° C., comprising:
(a) introducing the molten polymer feed into an extruder;
(b) cooling the molten polymer feed while in the extruder to raise the viscosity of the polymer feed to at least 5000 cP; and
(c) extruding the cooled polymer feed through a pelletizing die;
wherein the polymer feed is cooled to a temperature near the crystallization temperature of the polymer feed while in the extruder and the extruder increases the dispersive homogeneity of the polymer melt.
